(19) United States
(12) Patent Application Publication
(10) Pub. No.: US 2026/0328105 A1
(43) Pub. Date: Oct. 22, 2026

(54) Variable Vane and Lever Arms

(71) Applicant: RTX Corporation, Farmington, CT (US)

(72) Inventors: Samuel B. Hoyt, Farmington, CT (US); Fadi Samir Maalouf, East Hampton, CT (US)

(73) Assignee: RTX Corporation, Farmington, CT (US)

(21) Appl. No.: 19/564,756

(22) Filed: Mar. 12, 2026

Related U.S. Application Data
(60) Provisional application No. 63/791,279, filed on Apr. 18, 2025.

(51) Int. Cl. F01D 9/04

(52) U.S. Cl. CPC F01D 9/041; F05D 2220/32; F05D 2240/12

(57) ABSTRACT

A vane assembly has a vane and a vane arm. The vane has an airfoil and a shaft protruding from an end of the airfoil, the shaft having first and second lateral facets. The vane arm has a first end and a second end. A shank extends between the first end and the second end and has a first face and a second face. A first hole is in the shank proximate the first end and a second hole is in the shank proximate the second end. An end-section projects distally from the shank proximate the second end and has: a portion projecting back toward the first end and having first and second surfaces respectively contacting the first and second lateral facets.

### CROSSREFERENCE TO RELATED APPLICATION

Benefit is claimed of U.S. Patent Application No. 63791279, filed Apr. 18, 2025, and entitled “Variable Vane and Lever Arms”, the disclosure of which is incorporated by reference herein in its entirety as if set forth at length.

### BACKGROUND

The disclosure relates to variable lever arms. More particularly, the disclosure relates to vane lever arms such as used for variable vanes of a gas turbine engine.

Gas turbine engines (used in propulsion and power applications and broadly inclusive of turbojets, turboprops, turbofans, turboshafts, industrial gas turbines, and the like) may include variable vane stages in one or more sections of the engine. In a variable vane stage, a circumferential array of vane airfoils are each rotatable about the respective associated axis of rotation. The vane airfoils may each be mounted for such a rotation to an inner diameter (ID) platform/shroud or inner casing and an outer diameter (OD) shroud or outer casing. Vane rotation may be driven by respective lever arms typically mounted to an outer diameter (OD) shaft of the vane.

Example vane lever arms extend between a driving end and a driven end. The driving end includes one or more features for mounting to a driver such as a synchronizing ring. The driven end includes one or more features for mounting to the associated vane OD shaft/stem to rotate said vane about its axis of rotation.

A number of constructions of vane arms exist. United States Patent 10161260B2 (the ‘260 patent) of Morganti et al., December 25, 2018, entitled “Vane Lever Arm for a Variable Area Vane Arrangement”, discloses vane arms formed via bending sheet metal stock. The disclosure of the ‘260 patent is incorporated by reference in its entirety herein as if set forth at length. The vane may be formed by bending a cut generally T-shaped piece of the sheet stock. The driving end is formed at the end of the leg of the T and has a hole/aperture for accommodating a drive pin engaged by the synchronizing ring. The driven end is formed near the head or intersection of the leg and the arms of the T. Near the head/intersection, the leg has a hole/aperture for receiving a threaded shaft/stem of the vane.

The arms are bent around to overlap. The overlapping one of the arms has an aperture through which the vane shaft/stem passes in the mounted condition. The overlapped arm end protrudes over the overlapping arm aperture. A proximal portion of the vane shaft/stem is clamped by abutting contact of both a proximal edge of the overlapping arm aperture and the overlapped arm distal end.

To install the vane arm of the ‘260 patent to its associated vane, a tool is used to spread the arms slightly apart to reduce the overlap of the overlapped arm distal end and the overlapping arm aperture. The spreading provides clearance to install with the overlapping arm aperture passing over the threaded distal end portion of the shaft and over a region proximal of the threads having opposite parallel flats. Ultimately, the shaft passes through the head end aperture of the leg allowing a tab washer and nut to be installed and tightened down.

Releasing of the tool allows partial relaxation of the arms to compressively engage the shaft/stem proximal portion flats for registry. The head end hole in the ‘260 patent is partially circular with a circular arc and a chord providing a flat perimeter surface. In complementary fashion, the shaft threaded end portion has a flat interrupting the threads. The cooperation of the hole flat and shaft flat provides rotational keying to predetermine a single installation orientation of the vane arm relative to the vane. Although the non-circular cooperation of the hole and shaft/stem provides some rotational coupling, to withstand operational torques, additional rotational coupling is provided by the cooperation of the arms with the flats/facets of the shaft/stem.

FR2877059A1 (the FR ‘059 publication) shows bent sheet metal vane arms wherein the driven end of the arm is bent 180° back toward the driving end with a portion distally of the bend having a hole or a slot for capturing a faceted region of the vane stem. The threaded shaft of the stem passes through a hole in a shank of the vane arm proximally of the bend.

### SUMMARY

One aspect of the disclosure involves a vane assembly comprising a vane and a vane arm. The vane has an airfoil and a shaft protruding from an end of the airfoil, the shaft having first and second lateral facets. The vane arm has a first end and a second end. A shank extends between the first end and the second end and has a first face and a second face. A first hole is in the shank proximate the first end and a second hole is in the shank proximate the second end. An end section projects distally from the shank proximate the second end and has: a portion projecting back toward the first end and having first and second surfaces respectively contacting the first and second lateral facets.

In a further embodiment of any of the foregoing embodiments, additionally or alternatively, the first and second surfaces compressively engage the first and second lateral facets so that the end section is strained.

In a further embodiment of any of the foregoing embodiments, additionally or alternatively, the end section is dimensioned so that the first and second surfaces compressively engage the first and second lateral facets so that the end section is strained regardless of the relative orientation of the arm and vane about an axis of the shaft.

In a further embodiment of any of the foregoing embodiments, additionally or alternatively: the shaft has a third lateral facet between the first and second lateral facets; and the end section has a third surface contacting or facing the third lateral facet.

In a further embodiment of any of the foregoing embodiments, additionally or alternatively, the third surface is split.

In a further embodiment of any of the foregoing embodiments, additionally or alternatively, the end section has a fourth surface contacting or facing the shaft to a first end side of the vane arm.

In a further embodiment of any of the foregoing embodiments, additionally or alternatively, the fourth surface is arcuate and split.

A further embodiment of any of the foregoing embodiments may additionally or alternatively include a third hole closer to the second hole than to the first hole.

In a further embodiment of any of the foregoing embodiments, additionally or alternatively, the end section has one or more projections in the third hole.

In a further embodiment of any of the foregoing embodiments, additionally and/or alternatively the first, second, and third holes are in a single metallic piece.

A further embodiment of any of the foregoing embodiments may additionally or alternatively include a fourth hole between the third hole and the first hole and having a length between the first and second holes at least three times a width transverse thereto.

In a further embodiment of any of the foregoing embodiments, additionally and/or alternatively: the vane shaft has a shoulder; and a nut holds the vane arm to the shaft compressed between the nut and the shoulder.

In a further embodiment of any of the foregoing embodiments, additionally and/or alternatively, a tab washer is between the nut and the vane arm and has a tab received in a third hole or a recess in the vane arm.

A further embodiment of any of the foregoing embodiments may additionally or alternatively include a pin mounted in and protruding from the first hole.

In a further embodiment of any of the foregoing embodiments, additionally and/or alternatively, a vane stage comprises a plurality of said vane assemblies and further comprises: a synchronizing ring coupled to the vane arms and having an axis; and for each vane assembly one or more bearings mounting the vane for rotation about an axis of the vane wherein, rotation of the synchronizing ring about its axis rotates the vanes about their respective axes.

In a further embodiment of any of the foregoing embodiments, additionally and/or alternatively, a method for using the vane assembly comprises: via the arm applying torque to the vane to rotate the vane about an axis; and the torque bringing a third surface of the vane arm into contact with a third lateral facet of the shaft.

A further aspect of the disclosure involves a vane assembly comprising a vane and a vane arm. The vane has an airfoil and a shaft protruding from an end of the airfoil. The vane arm has a first end and a second end. A shank extends between the first end and the second end and has a first face and a second face. A first hole is in the shank proximate the first end and a second hole is in the shank proximate the second end and receiving the shaft. A forking end section has: first and second tines having respective ends; and first and second surfaces respectively of the first and second tines contacting the shaft to angularly register the arm to the vane about an axis of the shaft.

In a further embodiment of any of the foregoing embodiments, additionally and/or alternatively: the forking end section has a turn between the shank and the first and second surfaces; and a gap between the first and second tines extends into the turn to provide compliance for biasing contact of the first and second surfaces with the shaft.

A further aspect of the disclosure involves a vane assembly comprising a vane and a vane arm. The vane has an airfoil and a shaft protruding from an end of the airfoil. The vane arm has a first end and a second end. A shank extends between the first end and the second end and has a first face and a second face. A first hole is in the shank proximate the first end and a second hole is in the shank proximate the second end and receives the shaft. A section spaced apart from the shank and has: first and second surfaces contacting the shaft to angularly register the arm to the vane about an axis of the shaft; and means for providing compliance for biasing contact of the first and second surfaces with the shaft.

In a further embodiment of any of the foregoing embodiments, additionally and/or alternatively: the vane arm has a turn between the shank and the portion projecting back toward the first end; and the means comprises a gap between the first and second surfaces extending into the turn.

A further aspect of the disclosure involves a vane arm comprising: a first end and a second end; a shank extending between the first end and the second end and having a first face and a second face; a first hole in the shank proximate the first end; a second hole in the shank proximate the second end; a turn; and a portion distally of the turn and projecting back toward the first end and having a gap between first and second lateral sections, wherein: the gap extends into the turn.

In a further embodiment of any of the foregoing embodiments, additionally and/or alternatively, the turn is a bend.

In a further embodiment of any of the foregoing embodiments, additionally and/or alternatively, the gap has a laterally enlarged proximal portion along the turn.

A further embodiment of any of the foregoing embodiments may additionally and/or alternatively include the gap narrows along a portion to the first end side of an axis of the second hole.

In a further embodiment of any of the foregoing embodiments, additionally and/or alternatively, an enlarged region of the gap surrounding the axis of the second hole has a distal concavity.

A further embodiment of any of the foregoing embodiments may additionally and/or alternatively include, a third hole closer to the second hole than to the first hole.

In a further embodiment of any of the foregoing embodiments, additionally and/or alternatively, an end section distally of the turn has one or more projections in the third hole.

In a further embodiment of any of the foregoing embodiments, additionally and/or alternatively, a vane assembly includes the vane arm and further comprises a vane having an airfoil and a shaft protruding from an end of the airfoil, wherein: the vane shaft extends through the second hole; and a nut holds the vane arm to the shaft compressed between the nut and a shoulder of the vane.

A further aspect of the disclosure involves a vane arm comprising: a first end and a second end; a shank extending between the first end and the second end and having a first face and a second face; a first hole in the shank proximate the first end; a second hole in the shank proximate the second end; a turn; and a portion distally of the turn and projecting back toward the first end and having a gap between first and second lateral sections, wherein said the gap is partially bounded by: first and second lateral faces facing each other; first and second distally facing faces extending laterally inward from the first and second lateral faces; and first and second proximal faces facing each other and extending proximally from the first and second distally facing faces, respectively.

A further aspect of the disclosure involves a vane arm comprising: a first end and a second end; a shank extending between the first end and the second end and having a first face and a second face; a first hole in the shank proximate the first end; a second hole in the shank proximate the second end; a turn; and a portion distally of the turn and projecting back toward the first end and having a gap between first and second lateral sections, wherein said the gap is partially bounded by: first and second lateral faces facing each other; first and second proximally facing faces extending laterally inward from the first and second lateral faces; and first and second distal faces extending distally from the first and second proximally facing faces, respectively.

A further aspect of the disclosure involves a vane arm comprising: a first end and a second end; a shank extending between the first end and the second end and having a first face and a second face; a first hole in the shank proximate the first end; a second and third holes in the shank proximate the second end, the second hole between the third hole and the first hole; a turn; and a portion distally of the turn and projecting back toward the first end and having a gap between first and second lateral sections, wherein: a wall surface protrudes from the shank between the second hole and the third hole.

In a further embodiment of any of the foregoing vane arm embodiments, additionally and/or alternatively, a method for using the vane arm comprises: installing the arm to a vane so that: a shaft of the vane extending from an end of an airfoil of the vane passes through the second hole; and the first and second lateral faces or first and second lateral faces of the first and second lateral sections contact first and second lateral facets of the stem.

A further embodiment of any of the foregoing embodiments may additionally or alternatively include first and second proximally facing faces or the first and second proximally facing faces facing or contacting an arcuate surface of the stem.

A further embodiment of any of the foregoing embodiments may additionally or alternatively include first and second distally facing faces or the first and second distally facing faces facing or contacting a third facet of the stem circumferentially between the first and second lateral facets of the stem.

A further embodiment of any of the foregoing embodiments may additionally or alternatively include: installing a nut to a threaded portion of the shaft to hold the vane arm to the shaft the nut.

A further embodiment of any of the foregoing embodiments may additionally or alternatively include: installing a pin to the first hole.

In a further embodiment of any of the foregoing embodiments, additionally and/or alternatively, the method is performed with a plurality of vane arms and the respective pins are mounted to a shared synchronizing ring.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a vane assembly.

FIG. 2 is an enlarged partially exploded view of a vane actuating arm region of the assembly of FIG. 1.

FIG. 3 is a side view of the vane arm region.

FIG. 4 is a sectional view of the vane arm region taken along line 4-4 of FIG. 3.

FIG. 5 is a sectional view of the vane arm region taken along line 5-5 of FIG. 4.

FIG. 6 is a sectional view of the vane arm region taken along line 6-6 of FIG. 4.

FIG. 7 is an off-axis underside view of a tab-to-shank engagement of the vane arm region.

FIG. 8 is an outer diameter (OD) view of a distal end of an outer diameter (OD) shaft section of the vane of the assembly.

FIG. 9 is an inner diameter (ID) view of a vane arm of the assembly.

FIG. 10 is an OD view of the vane arm.

FIG. 11 is a side view of the vane arm.

FIG. 12 is a distal end view of the vane arm.

FIG. 13 is a side view of a second vane assembly having a second vane arm.

FIG. 14 is a sectional view of the vane arm region of the second vane assembly taken along line 14-14 of FIG. 13.

FIG. 15 is an ID view of the second vane arm.

FIG. 16 is a side view of the second vane arm.

FIG. 17 is a view of a third vane assembly having a third vane arm.

FIG. 18 is a sectional view of a vane arm region of the third vane assembly taken along line 18-18 of FIG. 17.

FIG. 19 is a sectional view of the vane arm region taken along line 19-19 of FIG. 18.

FIG. 20 is a sectional view of the vane arm region taken along line 20-20 of FIG. 18.

FIG. 21 is an ID view of the third vane arm.

FIG. 22 is an OD view of the third vane arm.

FIG. 23 is a side view of the third vane arm.

FIG. 24 is a view of a fourth vane assembly having a fourth vane arm.

FIG. 25 is a sectional view of a vane arm region of the fourth vane assembly taken along line 25-25 of FIG. 24.

FIG. 26 is a sectional view of the vane arm region taken along line 26-26 of FIG. 25.

FIG. 27 is a sectional view of the vane arm region taken along line 27-27 of FIG. 25.

FIG. 28 is an ID view of the fourth vane arm.

FIG. 29 is an OD view of the fourth vane arm.

FIG. 30 is a side view of the fourth vane arm.

Like reference numbers and designations in the various drawings indicate like elements.

### DETAILED DESCRIPTION

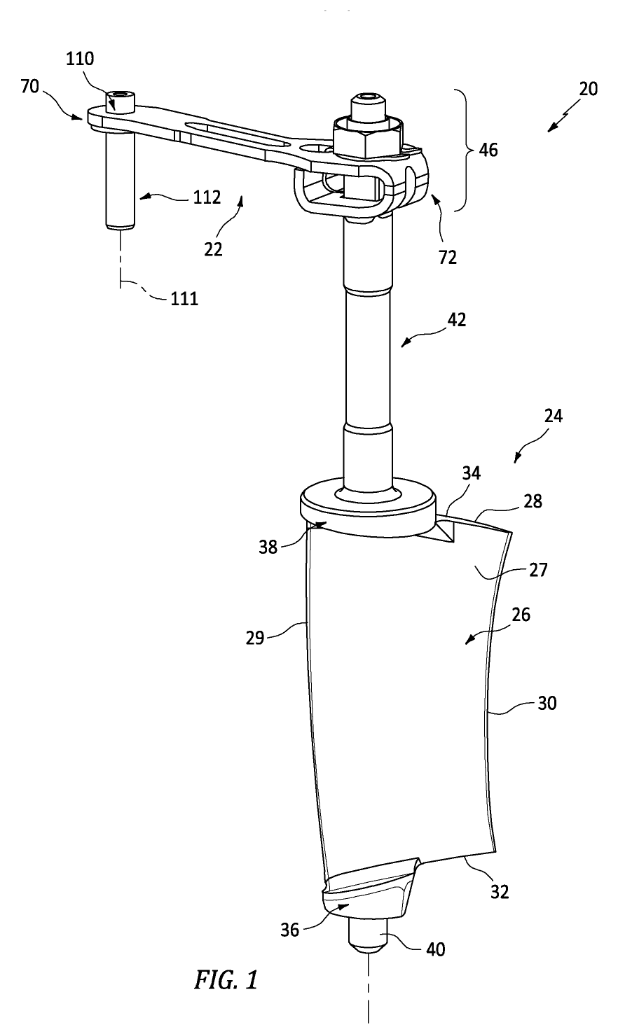

FIG. 1 shows a vane assembly 20 including vane arm 22 and vane 24 configured as a modification of the baseline of the ‘260 patent or FR ‘059 publication. The vane 24 includes an airfoil 26 having a pressure side 27, a suction side 28, a leading edge 29, and a trailing edge 30. The airfoil extends along a span from an inner diameter (ID) end 32 to an outer diameter (OD) end 34. Such ID and OD are measured essentially relative to the engine centerline. The airfoil ID and OD ends respectively merge, along forward/leading portions thereof, with respective ID and OD platforms 36 and 38. Respectively inward and outward from the platforms 36 and 38 are an ID shaft 40 and an OD shaft 42. The shafts are coaxial along a vane axis 44 which forms an axis of rotation and axis of threads of a threaded portion 50 discussed below. The OD shaft 42 includes a distal mounting section 46 for mating with the vane arm 22. Example vane materials are cast and machined metallic alloys such as nickel-based alloys and superalloys.

Relative to the ‘260 patent, the keying and rotational coupling provided by two lateral facets of the stem/shaft cooperating with two laterally bent arms/branches of the ‘260 patent vane arm is replaced by the stem/shaft cooperating with a single longitudinally-projecting structure projecting back toward the driving end of the vane arm radially inboard of a main shank thereof.

In several examples discussed below, the longitudinally-projecting structure may be of a bent tab partially resembling the lateral tabs of the ‘260 patent (but bent longitudinally rather than laterally) or the longitudinally bent tab of the FR ‘059 publication.

In other embodiments, the arm may be machined or cast (e.g., not of sheet metal) and the longitudinally projecting structure may be part of the machining/casting.

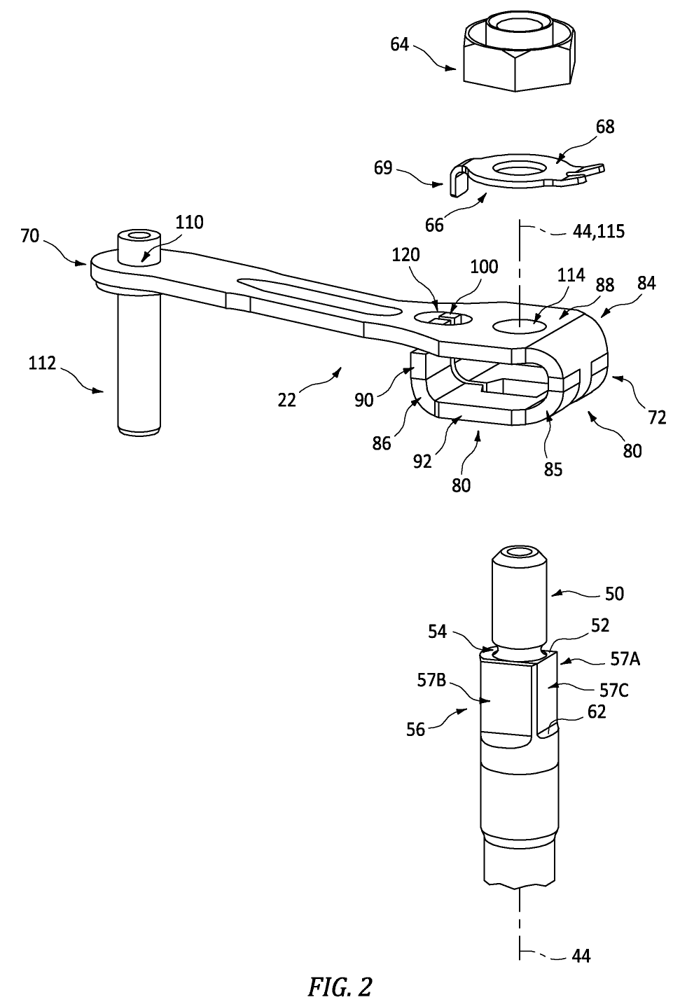

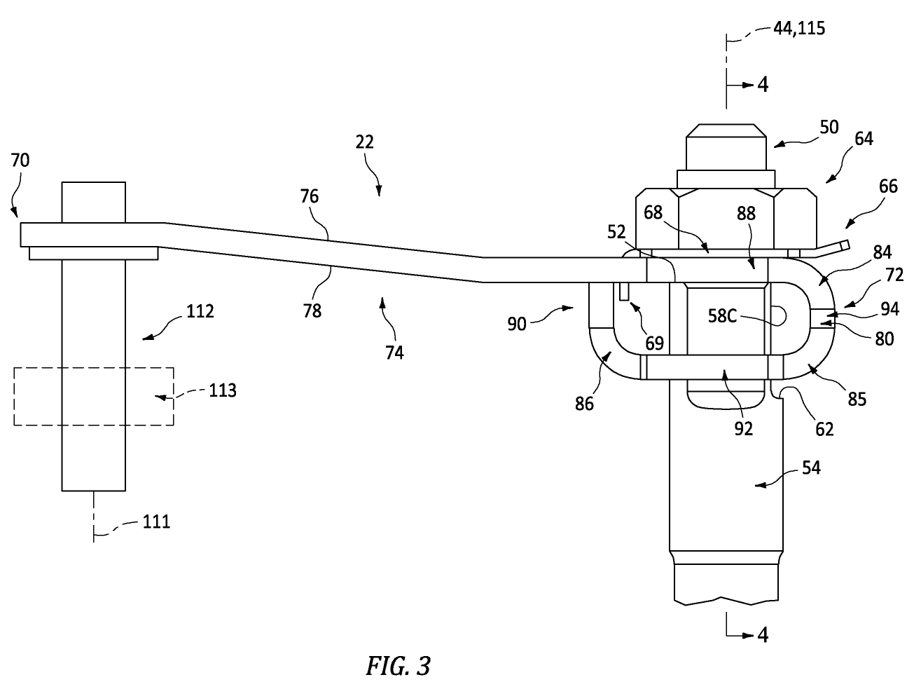

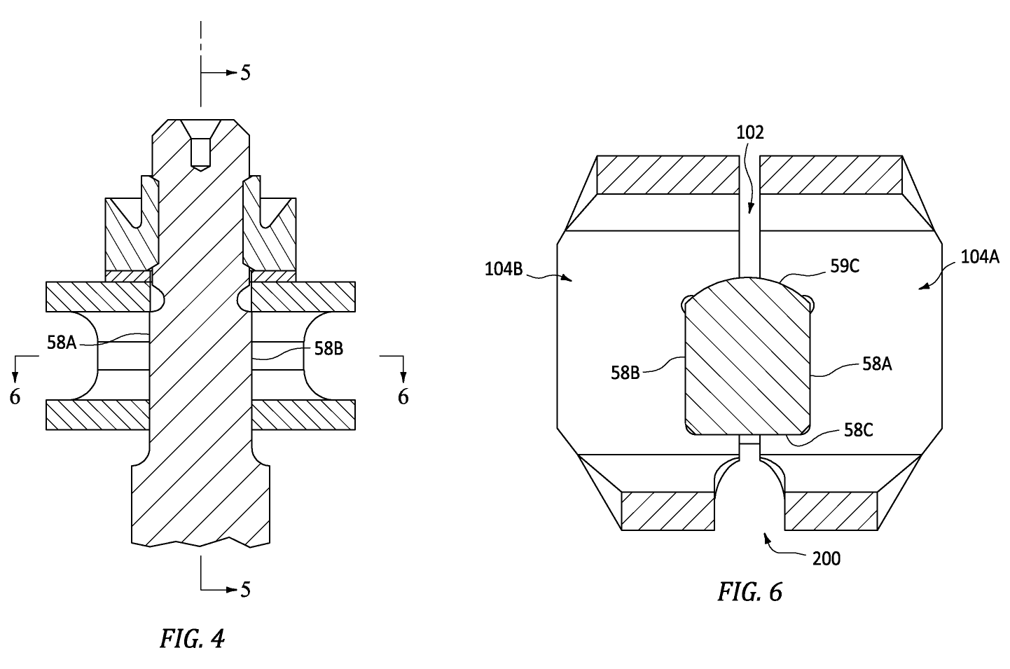

The mounting section 46 includes an externally threaded section/region/portion 50 (FIG. 2) with a shoulder surface 52 radially inward thereof or proximal relative to the airfoil. The shoulder 52 is separated from the threaded section by a necked region 54. Below/inward of the shoulder is a faceted section 56 having three faces 57A, 57B, 57C having respective facets 58A, 58B, 58C (FIG. 8) circumferentially interrupting an otherwise right circular cylindrical surface 59. FIG. 8 shows an intact portion 59C of such right circular cylindrical surface diametrically opposite the face 57A/facet 58A. Additionally, the example shows smaller circumferential extent intact portions 59A and 59B between the facet 58C and the respective faces 58A, 58B. The faces extend along a substantial majority of their axial length parallel to the axis 44 with a fillet 62 to the intact circular section of the shaft. In section normal to the vane axis 44, the facets 58A-58C form respective chords of a circle and have a respective width or chordlength W_{FA,} W_{FB}, W_{FC}. The facets are at respective separations S_{FA}, S_{FB}, and S_{FC} from the axis 44. In the example, W_{FA} and W_{FB} are equal as are S_{FA} and S_{FB}. W_{FC} is shorter than W_{FA} and W_{FB} and S_{FC} is greater than S_{FA} and S_{FB}. This leaves more intact shoulder 52 adjacent the face 57C/facet 58C than the lateral faces/facets. FIG. 3 also shows a nut 64 installed to the threaded section 50 and a tab washer 66 between the nut and the arm. The tab washer has an annular body 68 and a tab 69 bent at an angle thereto.

The arm 22 (FIG. 3) extends generally from a first end 70 to a second end 72. In this example, the first end 70 is a driving end and the second end 72 is a driven end. The example arm 22 is formed from stamped/bent sheet metal stock (e.g., nickel-based alloy/superalloy such as AMS 5596 - UNS N07718 (nominal 52.5Ni – 19Cr – 3.0Mo – 5.1Cb (Nb) – 0.90Ti – 0.50Al – 18Fe)). The arm 22 has a shank 74 extending between the first end and the second end and having a first face 76 and a second face 78. These faces 76 and 78 may correspond to faces of the sheet stock or relieved portions thereof. In some examples, a portion of the second face 78 may be relieved (not shown) relative to the original sheet stock for lightening. In an example method of manufacture, the stamped sheet stock piece may have an initial cut form of a generally straight strip planform/footprint vs. the T-like footprint of the pre-bending precursor to the vane arm of the ‘260 patent.

One end of the strip may ultimately form the first end 70 of the arm. The other end of the strip may ultimately form a distal end 100 (FIG. 2) of bent tab 80 projecting from the shank 74 proximate the second end. FIG. 3 shows the tab 80 in its bent configuration with one or more bends 84, 85, 86, extending from a second end portion 88 of the shank to a distal portion 90. The example bend(s) are each essentially 90° and have the effect of forming an essentially 270° turn. The tab includes an intermediate section/portion 92 generally parallel to and spaced apart from the shank end portion 88 and, proximally to distally, extending generally back in a direction from the second end to the first end. The example distal portion 90 is generally orthogonal to such shank end portion 88 and tab intermediate portion 92. The example tab has, opposite the distal portion 90, a more proximal portion 94 between the bends 84 and 85, with the portion 92 between the bends 85 and 86.

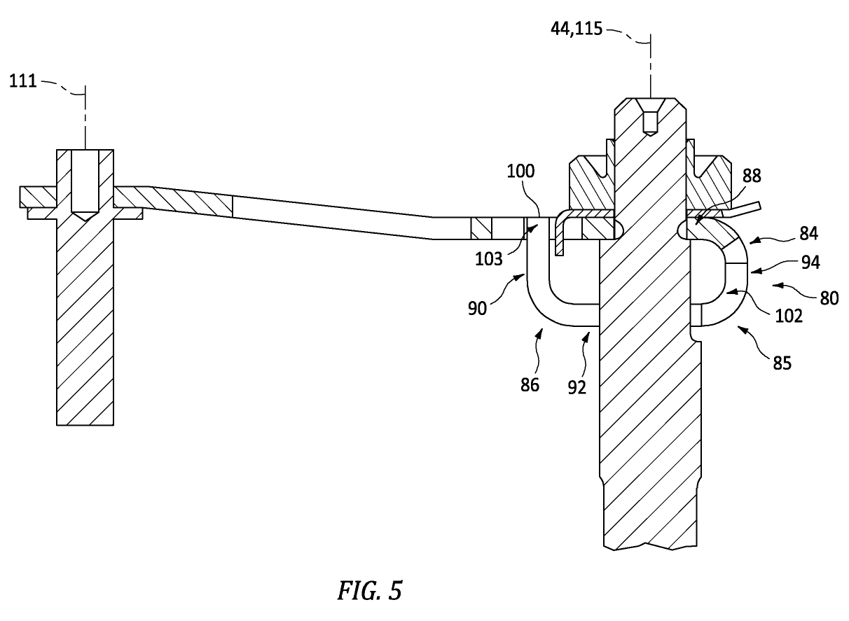

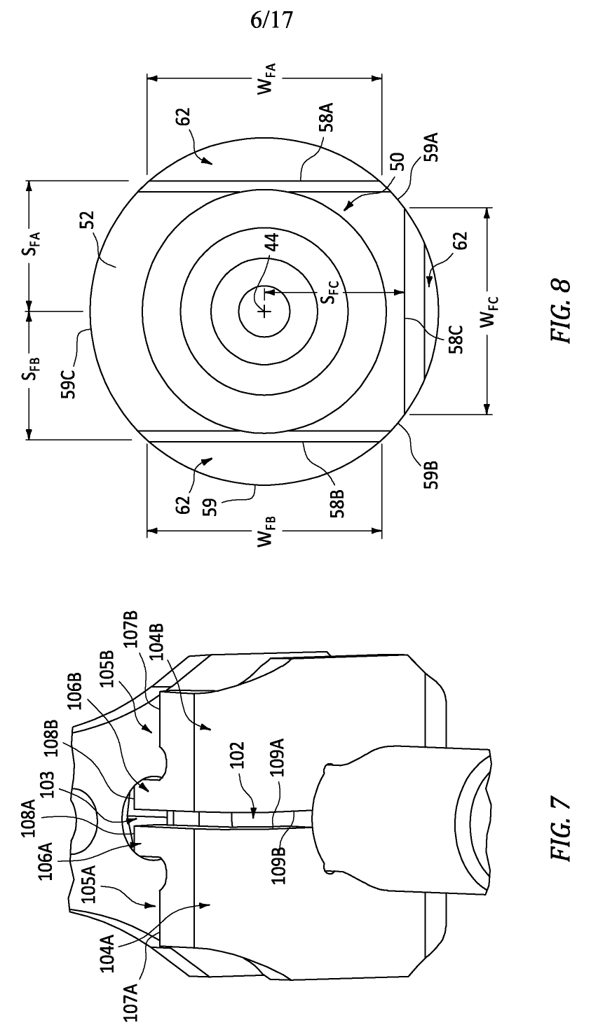

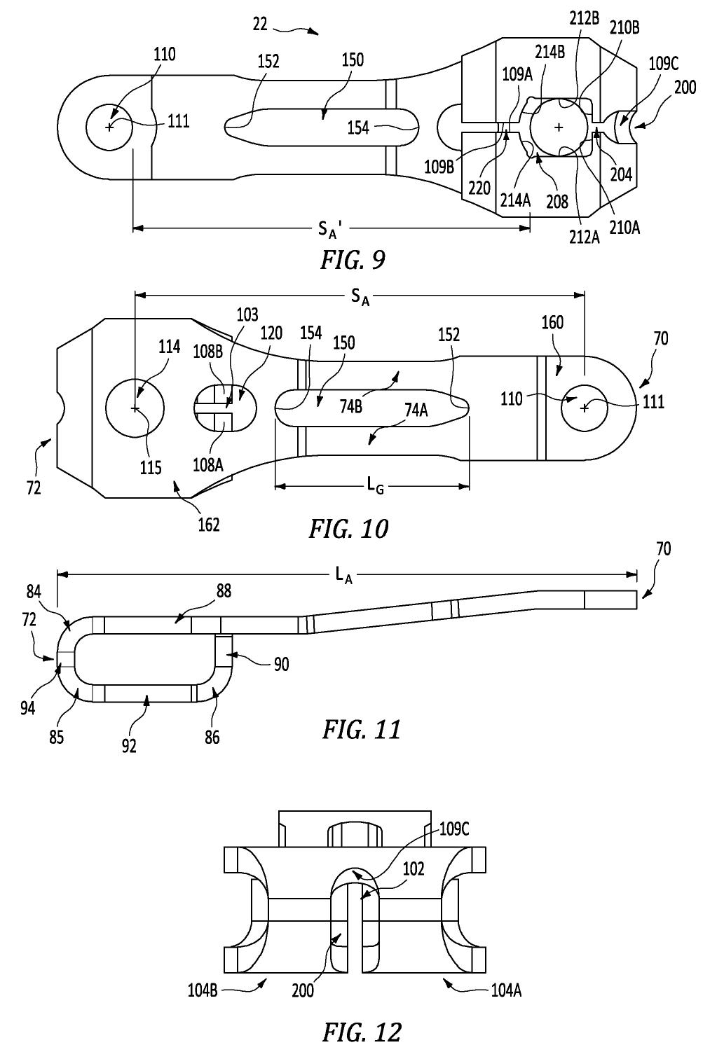

The tab extends to a distal end 100 (FIG. 2) which may represent the second end of the initial strip precursor as noted above. As is discussed further below, from at least one of the turns toward the distal end 100, the tab is bifurcated by a slot or gap 102 (FIG. 5&6). The example gap 102 extends to an open end 103 (FIG. 7) at the distal end 100 and divides first and second branches/arms/tines 104A, 104B. As discussed further below, the arms have stepped distal end sections 105A, 105B having inboard projections 106A, 106B protruding beyond outboard shoulder surfaces 107A, 107B and themselves having distal end surfaces 108A, 108B which may represent intact portions of the end face of the pre-bending precursor. The gap is bounded by a surface formed by laterally inboard surfaces 109A, 109B (FIG. 9) of the respective arms 104A, 104B meeting at/forming a concave junction 109C at a medial plane of the arm 22 and gap 102.

The gap 102 has a protuberant proximal portion 200 at the junction 109C. The example protuberant proximal portion 200 starts with a concave end at the junction 109C and proceeds with parallel side surfaces (portions of surfaces 109A, 109B) concavely converged toward each other at a distal end of the protuberant proximal portion 200. The concavity of the junction 109C acts as a stress relief to facilitate the lateral flexibility of the tines. The example proximal portion 200 starts in the bend 84, passes through the portion 94, and ends near a junction of the bend 85 with the intermediate portion 92. A narrow portion 204 (FIG. 9) extends distally from the protuberant portion and then opens up to a second protuberant portion 208. The second protuberant portion has, on the respective sides of the gap and branches/arms/tines, a transverse proximal surface section 210A, 210B, a longitudinally-extending section 212A, 212B, and then a concave arcuate section 214A, 214B. The portions 214A and 214B converge toward each other to again narrow the gap to a second narrow portion 220 which proceeds to the end 100. The second protuberant portion 208 has a footprint generally complementary to the cross-section of the stem faceted section 56 at the faces/facets. The identified surface sections of the second protuberant portion 208 may be joined to adjacent sections via quarter-round or similar stress relief features. The example second protuberant portion 208 fully overlaps the hole 114 when viewed parallel to the axis 44/115. During installation, this allows the stem threaded portion 50 to pass through the second protuberant portion 208.

In the installed condition, the surface sections 210A, 210B contact or closely face the facet 58C, the sections 212A, 212B contact or closely face the respective facets 58A and 58B, and the sections 214A, 214B contact or closely face the arcuate surface 59C. In a particular example, there is light lateral contact at both lateral facets 58A, 58B with slight strain acting to open the gap from a relaxed condition. This may be achieved with a camming action of the branches against beveling/chamfering/rounding of the transition between the lateral facet 58A, 58B and the shoulder surface 52. Due to manufacturing and assembly tolerances there may be many variations in contact at the facet 58C or surface 59C. Nominal dimensions might provide centered aligned clearance at both or a single one of those locations. Example such nominal clearance is 0.005 inch (0.13 millimeter, more broadly 0.05 to 0.25 millimeter for a net total of 0.10 to 0.50 millimeter) at both facet 58C and surface 59C. Slight variations in bending manufacture may cause contact at either with a slight gap at the other. Slight relative rotation may create partial contact at both (e.g., rotation in one direction creates stem contact by surfaces 210A and 214B and in the other direction by 210B and 214A).

The example vane arm has exactly four through-holes. A first through-hole 110 (FIG. 9&10) is adjacent the first end 70 for receiving a driving pin 112 (FIG. 1&2) which, in turn, is mounted to a synchronizing ring 113 (FIG. 3) in common with the pins of the other vanes of the stage and sharing a central longitudinal axis with the engine and the vane stage. A second through-hole 114 is near the second end and receives the OD shaft 42. The example second hole 114 is of circular cross-section dimensioned to just accommodate the threaded section 50 and allow the adjacent portion of the surface 78 to rest atop the shoulder surface 52 (FIG. 2). The hole 110 has an axis 111 shared with the pin 112. The second hole 114 has an axis 115 coaxial with the axis 44 in a mounted condition. An example hole-to hole on-center distance or separation S_{A} (FIG. 10) is about 1.5 inch (38 mm), more broadly 25 mm to 51mm or 37 mm to 43 mm. An example overall length L_{A} (FIG. 11) is about 1.7 inch (43 mm), more broadly 30 mm to 80 mm or 35 mm to 60 mm.

A third hole 120 is formed near the second hole 114 but to the first end side thereof to receive the washer tab 69 and projections 106A, 106B. The holes 110, 114, and 120 may be drilled or milled holes. Outboard lateral surfaces of the projections 106A, 106B may be closely accommodated/facing or contacting the adjacent lateral surfaces of the third hole 120. This further limits opportunity for angular misregistry in use. For example, any twist of the arm relative to the shaft/stem 42 about the axes 44, 115 will bias the two arm/tines 104A, 104B apart from each other broadening the gap 102. But this will bring the projections 106A, 106B into contact or into firmer contact with the adjacent surface portions of the third hole 120 resisting further outward flexing of the tines and thus further departure from angular registry about the axes 44, 115.

The modification relative to the ‘260 patent shifts the keying function from the second end hole 114 of the leg of the T to the surface sections 210A, 210B of the single bent tab cooperating with the flat/facet 57C. If the arm is installed 180° misoriented about the axis 44, the tab face adjacent surface sections 210A, 210B will come into contact with an intact portion of the shoulder 52 (at the surface 59C to block the further translation.

Additionally, the tab to shaft flat 57A-57C cooperation may provide torque transmission (particularly with any slight nut loosening). The surface sections 210A, 210B help maintain stem facet 57C engagement by the surface sections 210B, 210A, respectively upon any slight angular misregistry.

With keying provided by the tab 80, the keying function may be removed from the threaded portion of the shaft and the head end hole. Thus, the head end hole 114 may be circular in footprint and the shaft threads may be uninterrupted by the flat of the ‘260 patent.

Relative to the baseline, such modification may offer one or more of several advantages. The head end hole 114 may be easier to form (e.g., drill) as a pure circle relative to the baseline hole having a flat. The step of grinding the baseline shaft flat (that keys with the baseline hole flat) may be eliminated as may be any thread dressing or touch up required by pre-forming or post-forming the shaft flat. Weight may be reduced, particularly with small holes 114 (also enabling potential reduction in hole and thread diameter and nut size.

A further feature is that the shank 74 of the arm is bifurcated (FIG. 9&10) by an elongate hole or slot 150 (having first and second ends 152 and 154, respectively) into two parallel arm segments 74A and 74B between terminal end regions of the vane arm (e.g., a first end region 160 containing the first hole 110 and a second end region 162 containing the second and third holes and tab). Example length L_{G} of this hole or gap 150 is at least 25 percent or at least 30 percent of the overall length L_{A} of the vane arm, more particularly, 30 percent to 50 percent or 30 percent to 45 percent or 35% to 40%. Such length L_{G} may also be an example at least 40 percent of a hole 110 to hole 114 on center span S_{A} or closest proximity span S_{A}ʹ, more particularly 40 percent to 80 percent. Example slot width W_{G} is about 20% of L_{G}, more broadly 10% to 30% or 15% to 30% or 15% to 25%. The bifurcation may provide a lightening and/or strengthening combination in various embodiments.

Component materials and manufacture techniques and assembly techniques may be otherwise conventional. This may involve stamping/machining/press braking from plate stock. Circular holes may be drilled. The elongate slot may be formed by the initial stamping or by a machining operation such as a CNC end milling as may be other non-circular features.

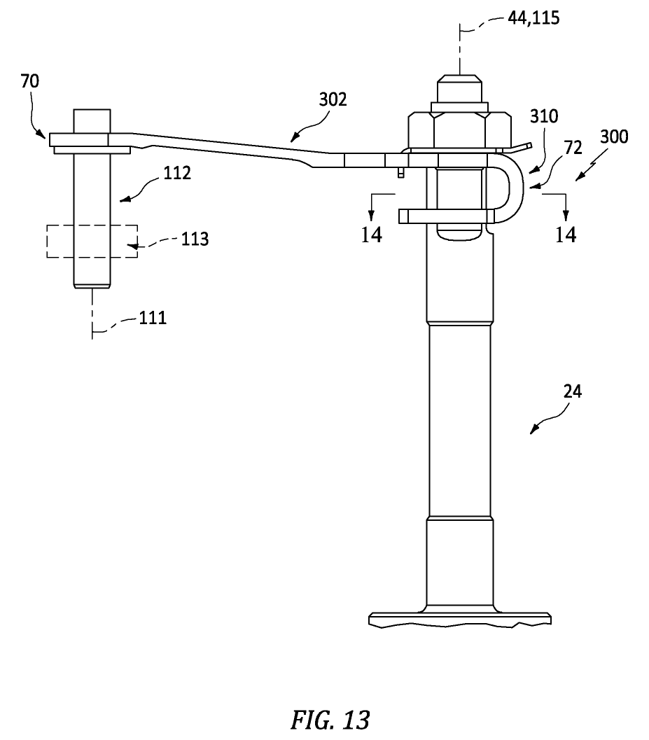

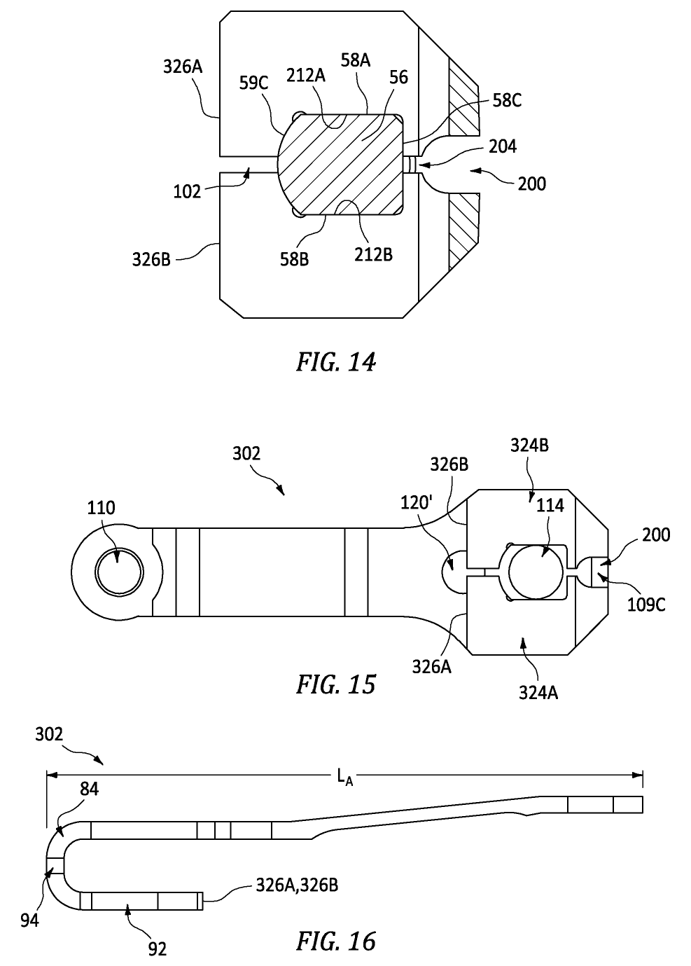

A second assembly 300 is a variation on the assembly 20 with a second bent sheet metal arm 302 is shown in FIGS. 13-16. In the illustrated example, the vane 24 is identical to that shown with the vane arm 22. The second vane arm 302 differs essentially in that the arm terminates distally essentially at the beginning or proximal end of the arm 22 third bend 86. Thus, the overall bend is an essentially 180° U-turn formed by bends 84, 85 rather than 270°. Accordingly, the second arm does not have a distal end contacting the shank underside or projections extending up into the hole 120. Whereas the example hole 120 is shown elongate so as to accommodate both the projections 106A, 106B and the washer tab, the corresponding hole 120ʹ (FIG. 15) of the second arm is shorter longitudinally (e.g., circular) because it only needs to accommodate the washer tab. Otherwise, surfaces are the same and are numbered the same. And manufacture and use are the same. Thus, the example tab or claw 310 (FIG. 13) has respective tines 324A, 324B which extend to ends 326A, 326B along the section 92 spaced apart from the shank. A similar gap 102 exists as does similar contacting or close facing of the facets or surfaces 58A, 58B, 58C, and 59C.

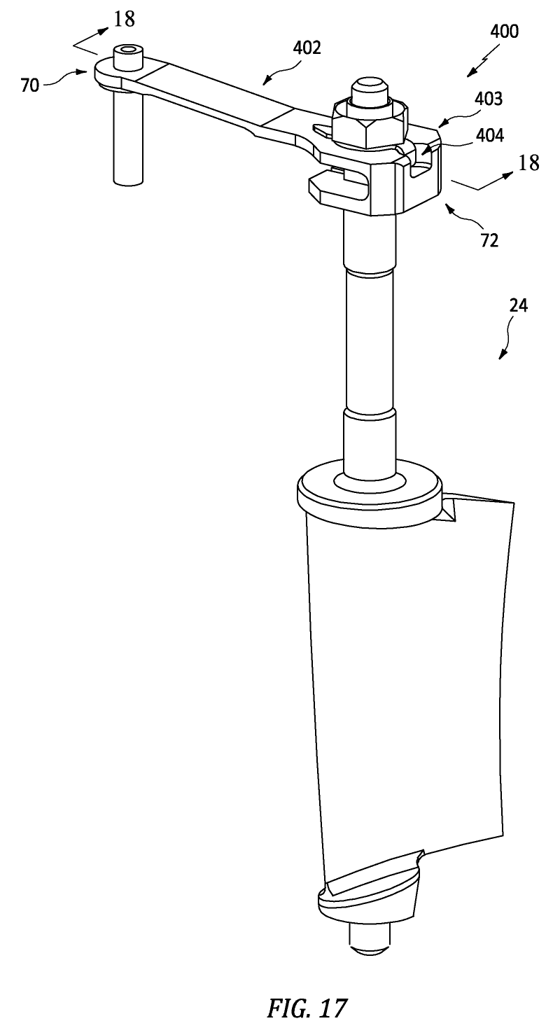

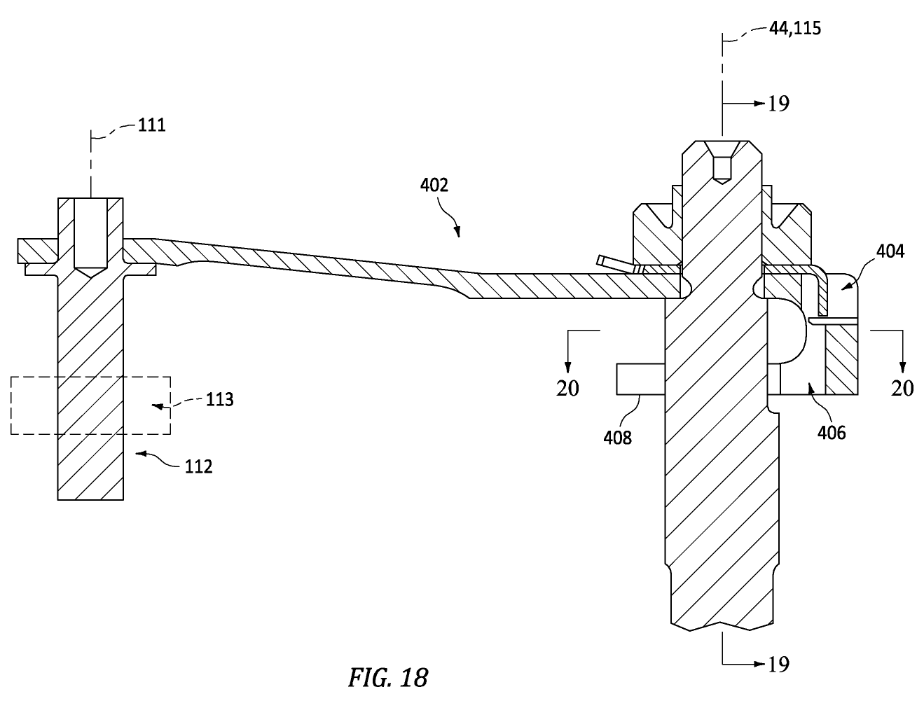

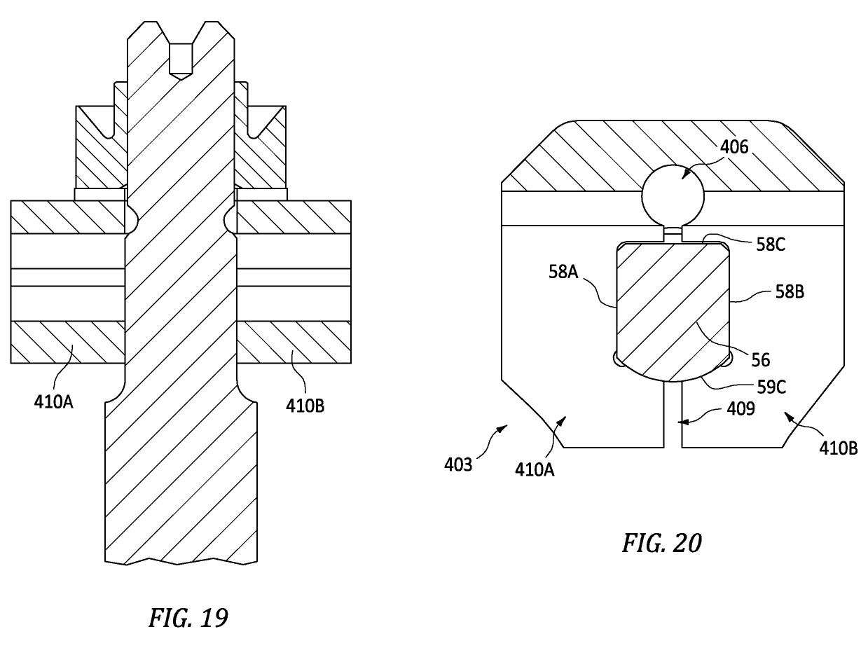

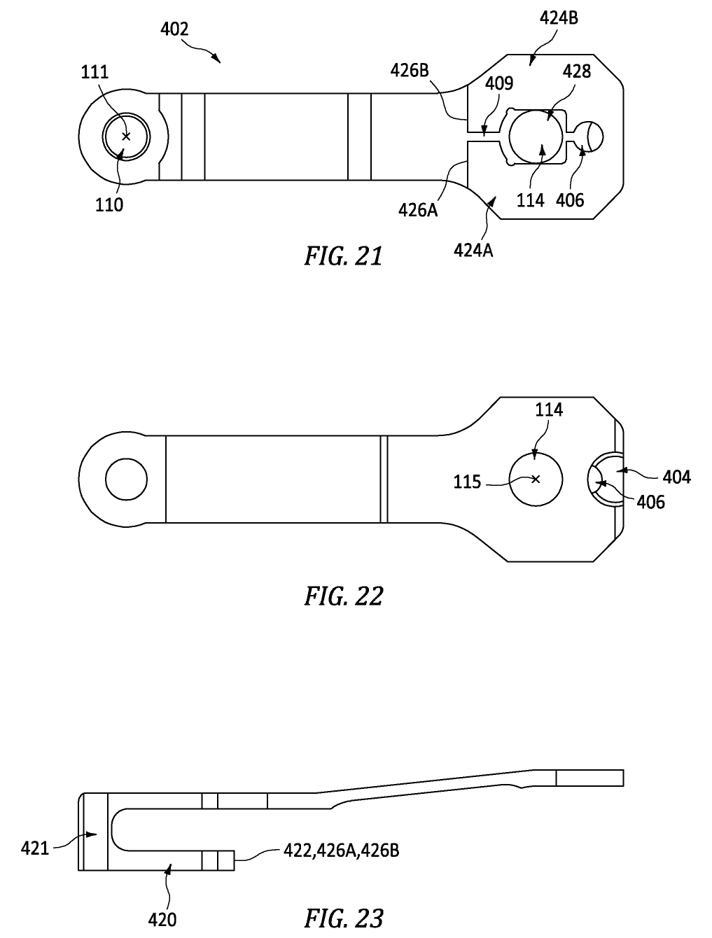

A third assembly 400 with a first non-sheet metal arm 402 is shown in FIGS. 17-23. This somewhat resembles the second bent sheet metal arm 302 in that it has a claw 403 forming 180° turn with stem-engaging faces generally the same as the two sheet metal embodiments. Although one option would be to essentially machine a counterpart to the arm 302, further example variations are shown. One example variation shown is that there is no hole in the location of the hole 120, 120ʹ of the two example sheet metal embodiments. Instead, the example tab washer is rotated 180° about the axis 44 and its tab 69 is received in a distal end pocket 404. The example pocket includes a recess in the outer face of the arm and open to the second end 72. The example recess is also open to a through-hole 406 (FIG. 18) extending from the underside of the tab or claw 403 and which forms a terminus of the slot/gap 409 between the two branches/arms/tines 410A, 410B that provides lateral compliance/bias. Similar to the section 92, the claw 403 has a distal section 420 (FIG. 23) having tines 424A, 424B extending to distal ends 426A, 426B. As with the arm 302, protuberant region 428 of the gap 409 is between a proximal necked/narrowed region near the through hole 406 and a distal necked/narrowed region toward the ends 426A, 426B which form the claw distal end. The protuberant region 428 may have similar surfaces to those described for the arm 302. An end wall portion 421 joins the shank to the distal portion 420 and it is this end wall portion that bears the recess 404 and through hole 406.

Component materials and manufacture techniques and assembly techniques may be otherwise conventional. As with the sheet metal embodiments, example materials include the aforementioned nickel-based alloys/superalloys. Manufacture may be via machining from billet stock or by casting and machining or by additive manufacture and machining. Installation and use may be similar to that of the other embodiments.

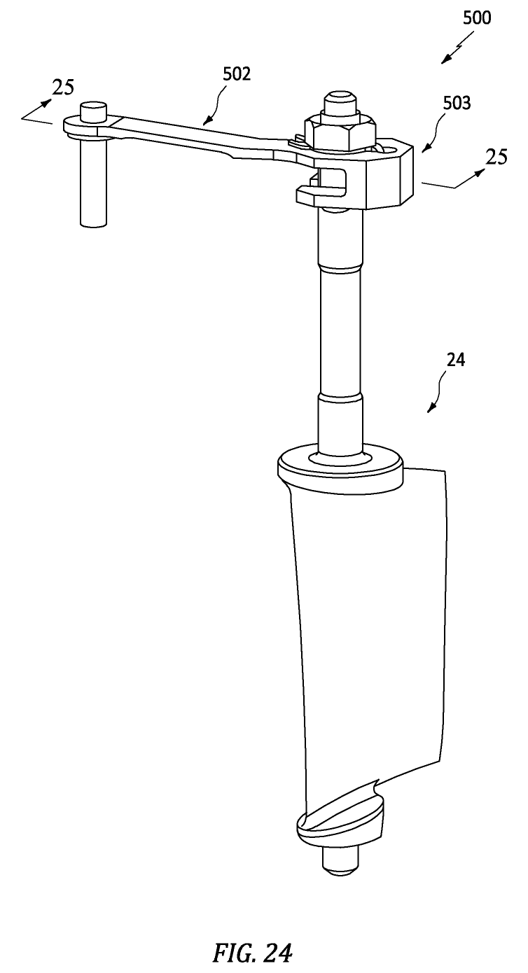

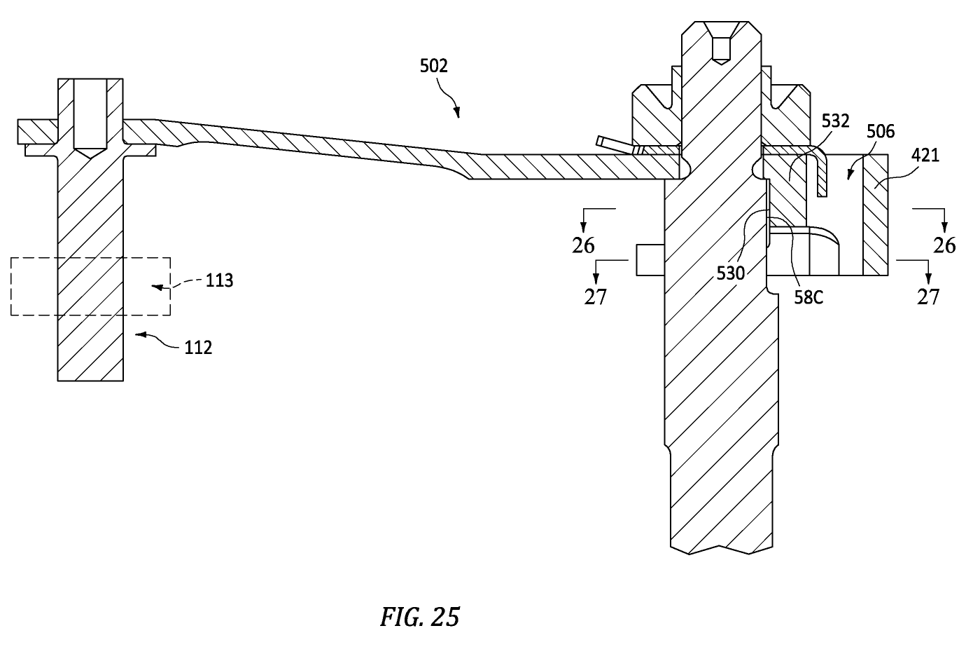

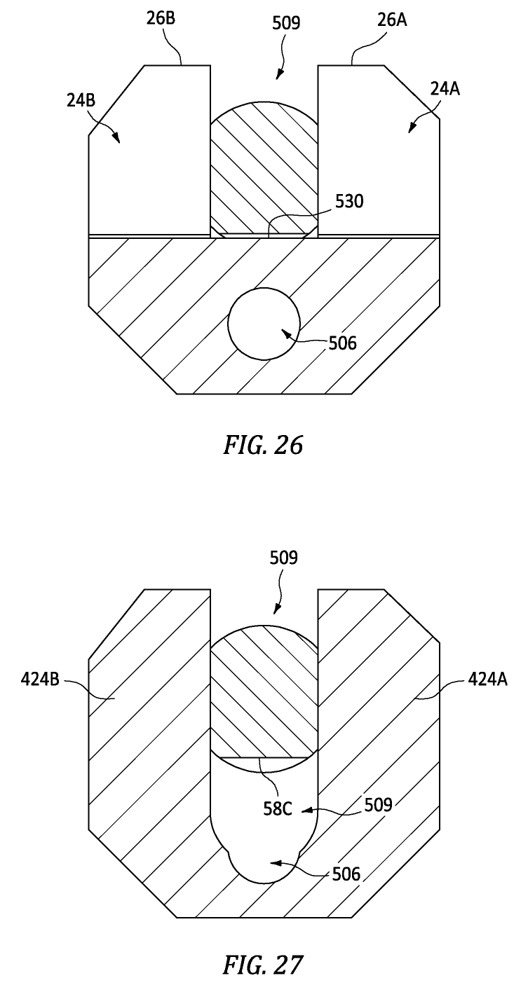

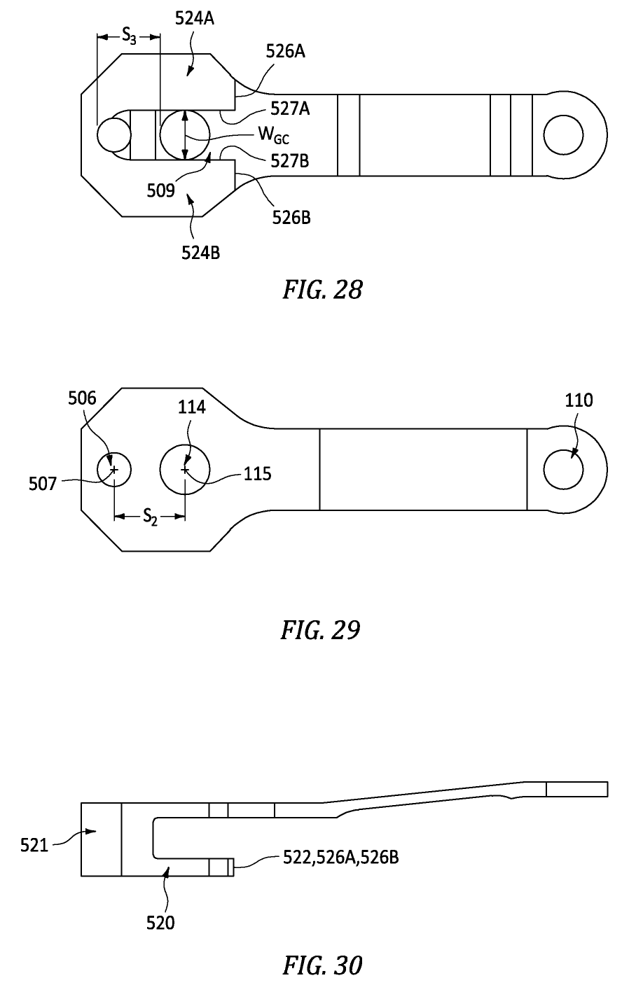

A fourth assembly 500 with a second non-sheet metal arm 502 is shown in FIGS. 24-30. The arm has a claw 503. The claw has a distal section 520 (FIG. 30) extending to an end 522 formed by ends 526A, 526B (FIG. 28) of tines 524A, 524B. The tab-receiving hole 506 (FIG. 29) extends through the end wall and merges with the gap 509 at a proximal end thereof. The hole 506 is shown having an axis 507. The example hole 506 is of circular form and merges with the gap 509 so that the circular form of the hole forms a central portion of the closed proximal end of the gap. The example hole 506 is of smaller diameter than the holes 110 and 114. The tines have laterally inboard surfaces 527A, 527B separated by a gap width W_{GC} (FIG. 28) for respectively engaging the facets 58A, 58B. FIG. 29 shows an axis to axis spacing S₂ of the hole 114. FIG. 28 shows a separation S₃ of the second end extremes of the holes 114 and 506. To provide lateral compliance of the claw gap 509, S₃ may be larger than the hole diameters and larger than the claw gap width W_{GC} in the region that ultimately transversely contacts the stem (e.g., 100% to 200% of the diameter of hole 114 or W_{GC}, or, more broadly, 75% to 200%).

Relative to the vane arm 402, the vane arm 502 shifts the contact or close facing location from the face 57C/facet 58C. The two branches/tines/arms 524A, 524B respectively still contact the associated lateral faces/facets 58A, 58B. But their respective inboard surfaces 527A, 527B along the gap do not engage the face 57C/facet 58C. Instead, the gap extends with a wide spacing relatively proximally of the lateral contact locations. The third contact or facing proximity location is, instead, a surface 530 of an interior shoulder 532 between the arm’s vane stem hole 114 and the washer tab-receiving hole 506. An axial span (parallel to axes 44, 115) of the close facing area of surfaces 530 and 58A may be the about the same as or greater than the axial contact spans of the arms and facets 58A, 58B. Close facing proximity may be as above. Manufacture may be the same as for the third embodiment. Installation, and use may be the same as with the other three embodiments.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing baseline vane arm configuration, details of such baseline may influence details of particular implementations. Accordingly, other embodiments are within the scope of the following claims.

What is claimed is:

1. A vane assembly comprising:
a vane having an airfoil and a shaft protruding from an end of the airfoil, the shaft having first and second lateral facets; and
a vane arm comprising:
a first end and a second end;
a shank extending between the first end and the second end and having a first face and a second face;
a first hole in the shank proximate the first end;
a second hole in the shank proximate the second end and receiving the shaft; and
an end section projecting distally from the shank proximate the second end and having:
a portion projecting back toward the first end and having first and second surfaces respectively contacting the first and second lateral facets.

2. The vane assembly of claim 1 wherein:
the first and second surfaces compressively engage the first and second lateral facets so that the end section is strained.

3. The vane assembly of claim 1 wherein:
the end section is dimensioned so that the first and second surfaces compressively engage the first and second lateral facets so that the end section is strained regardless of the relative orientation of the arm and vane about an axis of the shaft.

4. The vane assembly of claim 1 wherein:
the shaft has a third lateral facet between the first and second lateral facets; and
the end section has a third surface contacting or facing the third lateral facet.

5. The vane assembly of claim 4 wherein:
the third surface is split.

6. The vane assembly of claim 4 wherein:
the end section has a fourth surface contacting or facing the shaft to a first end side of the vane arm.

7. The vane assembly of claim 6 wherein:
the fourth surface is arcuate and split.

8. The vane assembly of claim 1 wherein the vane arm further comprises:
a third hole closer to the second hole than to the first hole.

9. The vane assembly of claim 8 wherein:
the end section has one or more projections in the third hole.

10. The vane assembly of claim 8 wherein:
the first, second, and third holes are in a single metallic piece.

11. The vane assembly of claim 8 wherein the vane arm further comprises:
a fourth hole between the third hole and the first hole and having a length between the first and second holes at least three times a width transverse thereto.

12. The vane assembly of claim 1 wherein:
the vane shaft has a shoulder; and
a nut holds the vane arm to the shaft compressed between the nut and the shoulder.

13. The vane assembly of claim 12 wherein:
a tab washer is between the nut and the vane arm and has a tab received in a third hole or a recess in the vane arm.

14. The vane assembly of claim 12 further comprising:
a pin mounted in and protruding from the first hole.

15. A vane stage comprising a plurality of vane assemblies of claim 1 and further comprising:
a synchronizing ring coupled to the vane arms and having an axis; and
for each vane assembly one or more bearings mounting the vane for rotation about an axis of the vane wherein, rotation of the synchronizing ring about its axis rotates the vanes about their respective axes.

16. A method for using the vane assembly of claim 1, the method comprising:
via the arm applying torque to the vane to rotate the vane about an axis; and
the torque bringing a third surface of the vane arm into contact with a third lateral facet of the shaft.

17. A vane assembly comprising:
a vane having an airfoil and a shaft protruding from an end of the airfoil; and
a vane arm comprising:
a first end and a second end;
a shank extending between the first end and the second end and having a first face and a second face;
a first hole in the shank proximate the first end;
a second hole in the shank proximate the second end and receiving the shaft; and
a forking end section having:
first and second tines having respective ends; and
first and second surfaces respectively of the first and second tines contacting the shaft to angularly register the arm to the vane about an axis of the shaft.

18. The vane assembly of claim 17 wherein:
the forking end section has a turn between the shank and the first and second surfaces; and
a gap between the first and second tines extends into the turn to provide compliance for biasing contact of the first and second surfaces with the shaft.

19. A vane assembly comprising:
a vane having an airfoil and a shaft protruding from an end of the airfoil; and
a vane arm comprising:
a first end and a second end;
a shank extending between the first end and the second end and having a first face and a second face;
a first hole in the shank proximate the first end;
a second hole in the shank proximate the second end and receiving the shaft;
a section spaced apart from the shank and having:
first and second surfaces contacting the shaft to angularly register the arm to the vane about an axis of the shaft; and
means for providing compliance for biasing contact of the first and second surfaces with the shaft.

20. The vane assembly of claim 17 wherein:
the vane arm has a turn between the shank and the portion projecting back toward the first end; and
the means comprises a gap between the first and second surfaces extending into the turn.
